(19) United States
(12) Patent Application Publication
(10) Pub. No.: US 2026/0125207 A1
(43) Pub. Date: May 7, 2026

(54) SEALABLE POLYPROPYLENE FIBC AND FIBC PARTS

(71) Applicant: FPS Investments B.V, Amstelveen (NL)

(72) Inventor: Afsin Dogan, Istanbul (TR)

(21) Appl. No.: 19/382,762

(22) Filed: Nov. 7, 2025

(30) Foreign Application Priority Data
Nov. 7, 2024 (EP) 24211420.5

(51) Int. Cl. B65D 90/02; B32B 5/02; B32B 27/08; B32B 27/12; B32B 27/32; B65D 88/16; C09J 123/12; D06N 3/00; D06N 3/04

(52) U.S. Cl. CPC B65D 90/022; B32B 5/024; B32B 27/08; B32B 27/12; B32B 27/32; B65D 88/1612; C09J 123/12; D06N 3/0006; D06N 3/0038; D06N 3/045; B32B 2255/02; B32B 2255/26; B32B 2262/0253; B32B 2307/31; B32B 2307/718; B32B 2307/7376; B32B 2439/06; D06N 2201/0218; D06N 2211/00

(57) ABSTRACT

Sealable fabric for a flexible intermedia bulk container (FIBC) for receiving bulk material including a woven fabric including polypropylene, a coating including polypropylene and a sealable film including sealable polypropylene, particularly sealable polypropylene resin.

### TECHNICAL FIELD OF THE INVENTION

The present invention relates to a sealable fabric and a Flexible Intermediate Bulk Container (FIBC) made of a sealable fabric.

A flexible intermedia bulk container (FIBC) or big bag is an industrial container made of flexible fabric designed for storing and transporting dry and/or flowable products e.g. sand, fertilizer or granules. A FIBC usually has a filling volume of about 1000 l-1300 l and can be filled with approximately 1000 kg- 1500 kg.

### BACKGROUND OF THE INVENTION

A FIBC or big bag comprises a plurality of woven fabrics made of polypropylene. Such woven polypropylene fabrics comprise a high strength and are chemically inert. During manufacturing of a FIBC or a big bag the woven polypropylene fabrics are usually sewed together. However, the sewing reduces the strength of the woven polypropylene fabrics through the needle punctures and thus damaging of the fabric. In addition, sewing can result in leakage problems, contamination problems and is usually a time consuming, e.g. manual, process. A FIBC or big bag usually comprises an inner liner, e.g. comprising low density polyethylene (LDPE), to protect the filling product. The inner liner is typically fixed to the FIBC or big bag by adhesives or by using adhesive tapes. Depending on the filling conditions of the FIBC, the fixation of the inner liner can be separated and/or the handling the FIBC with the inner liner can be more difficult compared to a FIBC without an inner liner.

US 2014/0363106 A1 teaches an alternative method for producing a flexible polypropylene fabric wherein the polypropylene fabrics comprise a coated and an uncoated side. During manufacturing, the coated sides of two polypropylene fabrics are joined together by applying heat to the polypropylene fabrics.

It is an object of the invention to provide a sealable fabric for a FIBC having increased properties for manufacturing a FIBC and reducing contamination and leakage risks.

The problem is solved by a sealable fabric and a Flexible Intermediate Bulk Container (FIBC).

### SUMMARY OF THE INVENTION

According to the invention, a sealable fabric for a flexible intermediate bulk container (FIBC) or big bag for receiving bulk material is provided. The sealable fabric comprises a woven fabric comprising polypropylene, additionally sealable polypropylene, a coating comprising polypropylene, additionally sealable polypropylene, and a sealable film comprising a sealable polypropylene, sealable polypropylene resin. Hence, the sealable fabric is particularly formed by different layers, a first layer comprising the woven fabric, a second layer comprising the coating and a third layer comprising the sealable film.

The coating is provided between the woven fabric and the sealable film to bond the woven fabric and the sealable film. The sealable film provides the effect that the sealable fabric can be sealed to another sealable fabric by means of a sealing technology. The sealable fabrics can be sealed by applying heat to a sealing area of the sealable fabrics. Hence, a sewing operation can be eliminated. Due to the sealing process, the sealable fabric is not damaged providing a high strength of the joined sealable fabrics. Additionally, the main component of the sealable fabric is polypropylene. Hence, the whole sealable fabric can easily be recycled providing a high degree of sustainability. Particularly, the woven fabric is the load-bearing layer of the sealable fabric.

A sealable structure and/or material, PP and/or PE, is a structure/material which can be sealed by applying a temperature of at least the melting point of the material, plus at least 10° C., further plus at least 20° C., and/or by applying a temperature of at least 80° C., optionally at least 100° C., further optionally at least 140° C., further optionally at least 160° C., further optionally at least 200° C. and/or less than 300° C., optionally less than 200° C. Most, a temperature in a range between 100° C.-200° C. is used for sealing.

The structure according to the invention exhibits particularly good sealability resulting from a specific combination of polypropylene-based materials having complementary thermal and rheological properties. Sealable polypropylene resin provides a low seal initiation temperature and moderate melt flow rate, ensuring rapid surface melting and efficient chain interdiffusion at relatively low temperatures. A low fluidity polypropylene heterophasic copolymer provides higher softening temperature and mechanical stability, preventing deformation and maintaining high seal integrity during the heat-sealing process.

The woven fabric is particularly manufactured of warp and weft yarns.

In an embodiment the woven fabric, particularly the yarns of the woven fabric, further comprises a sealable polypropylene, sealable polypropylene resin, and/or colorant and/or protective additives. Due to the sealable polypropylene, the bonding strength between the different layers of the sealable fabric can be increased during the sealing process. The protective additives can comprise protection against ultraviolet (UV) radiation and/or against splitting of the woven fabric. The anti-splitting additives comprise calcium carbonate. Hence, the lifetime of the sealable fabric is increased. The woven fabric, particularly the yarn of the woven fabric, does not comprise polyethylene (PE).

The woven fabric, particularly the yarn of the woven fabric, comprises the following proportions of the components:
Polypropylene: 50%-70%, 60% -65%; and/or
Anti-splitting additives: 2%-8%, 4%-6%; and/or
Sealable polypropylene, sealable polypropylene resin: 20%-40%, 25%- 35%; and/or
UV protective additives: 1%-2%, 1.25%-1.75%; and/or
Colorant: 0.25%-0.75%.

Due to the high amount of polypropylene, the woven fabric provides a high sustainability and can easily be recycled after its use.

In an embodiment, the woven fabric has a weight of 40 g/m²-300 g/m², 55 g/m²-250 g/m², 75 g/m²-235 g/m², providing a sufficient strength of the woven fabric.

In a further embodiment, the coating further comprises a sealable polypropylene, particularly a sealable polypropylene resin, and/or polyethylene, linear low-density polyethylene (LLDPE). The coating comprises the following proportions of the components:
Polypropylene: 30% -60%, 40% -50%; and/or
polyethylene, linear low-density polyethylene (LLDPE): 2%-8%, 4%- 6%; and/or
sealable polypropylene resin: 35%-65%, 45%-55 %.

The coating has a weight of 15 g/m²-35 g/m², 20 g/m²-30 g/m².

In an embodiment, the sealable film further comprises polyethylene, linear low-density polyethylene (LLDPE) and/or low-density polyethylene (LD-PE) and/or a low fluidity polypropylene heterophasic copolymer and/or a tie material and/or sealable polypropylene, e.g. sealable polypropylene being a C2/C4 terpolymer.

The sealable film comprises at least one first layer, e.g. an outer (outer most) layer, and/or at least one second layer, e.g. an internal layer, and/or at least one third layer, e.g. a tie (bonding) layer. The layers of the sealable film can provide different mechanical and chemical properties, which may be adapted to the planned use of the sealable fabric. The at least one first layer of the sealable film may particularly be adapted to the properties of adjacent layers, e.g. the coating and/or another sealable film and/or a sealable fabric, to provide a good bonding. The at least one second layer may by adapted to increase the flexibility of the sealable film. The at least one third layer increases the bonding between the second layer and the first layer. The first layer surrounds the second layer and/or the third layer so that the first layer forms the outer surface of the sealable film.

In an embodiment, the first layer of the sealable film comprises at least 80%, at least 90%, most at least 98%, sealable polypropylene, sealable polypropylene being a C2/C4 terpolymer, and/or sealable polypropylene resin and/or low fluidity polypropylene heterophasic copolymer. The first layer contains substantially only sealable polypropylene, sealable polypropylene resin. Hence, the bonding between the sealable film and a sealable film of another sealable fabric and/or the bonding to the coating may be increased.

In a further embodiment, the second layer comprises the polyethylene, linear low-density polyethylene (LLDPE) and/or low-density polyethylene (LD-PE). Hence, the elasticity of the second layer and thus of the sealable film can be increased. Furthermore, the polyethylene components of the second layer may reduce the rigidity and/or increase the flexibility of the sealable film.

The third layer comprises the tie material increasing the bonding between the second layer and the first layer. The third layer is in between the first layer and the second layer.

The sealable film is a coextruded film, so that the sealable film comprising the first layer and/or the second layer and/or the third layer may be manufactured in one single production step. The sealable film can also be considered as inner liner of regular FIBCs or big bags with barrier properties like a low density polyethylene (LDPE) liner.

The sealable film is manufactured by a multilayer blown film method or line, by a multilayer blown film coextrusion method or line, or different extrusion lines.

The sealable film may for example have a thickness of 30 μm-160 μm, of 30 μm-75 μm, of 35 μm-45 μm.

The abovementioned problem is solved by a Flexible Intermediate Bulk Container (FIBC) or big bag for receiving bulk material comprising at least one sheet of sealable fabric according to the invention. The sheets of sealable fabric form a leak-proof seamless or stitchless usable space or internal volume having at least one body fabric or side element and a bottom element. The at least one sheet of sealable fabric forms the at least one body fabric and/or the bottom element and/or top element and/or a loop, e.g. handle, of the FIBC. Moreover, the at least one sheet of sealable fabric may be used for a filling spout, attached to the top element, and/or a discharge spout, attached to the bottom element, and/or inner baffles, attached to at least one body fabric. Furthermore, the filling spout and/or the discharge spout may each comprise at least one tie for closing the discharge spout and/or filling spout. Furthermore, the at least one sheet of sealable fabric may be used for a skirt, that is attached to the body fabric. Hence, a FIBC is provided wherein the sheets of sealable fabrics are joined without any sewing operation. Hence, leakage problems and/or contamination problems of the FIBC or big bag can be avoided. In addition, the manufacturing process is simplified.

The at least one sheet of sealable fabric is sealed together in sealing areas, provided along the edges of the FIBC. The fabrics are sealed together by applying heat to the sealable film so that the sealable film melts. The heat is particularly applied heating elements or induction heating or ultrasound waves or laser radiation.

The sealable fabric can be used for all components of the FIBC or big bag, or be used for at least 50 wt.-%, at least 90 wt.-% of the FIPBC/big bag. Alternatively, the sealable fabric can be used for some components of the FIBC. The sealable fabric can be used for the filling spout and/or the discharge spout and/or the at least one skirt and/or the at least one body fabric and/or the bottom element and/or top element and/or bottom body and/or a top body and/or a vertical seal of the filling spout and/or a vertical seal of the discharge spout and/or a round seal of filling spout to the top element and/or round seals of a discharge spout to the bottom element and/or a, e.g. inner, baffle to the side body.

The sealable fabric can furthermore or alternatively be used for vertical seals of a filling spout and/or vertical seals of discharge spout and/or vertical seals of the skirt. Alternatively or additionally, the sealable fabric can be used for sealing or welding the filling spout to top element and/or sealing or welding the filling skirt to body element and/or sealing or welding the discharge spout to bottom element. Additionally or alternatively, the sealable fabric can be used for sealing or welding the top element and/or the bottom element to the body fabric. Moreover, the sealable fabric can be used for sealing or welding the inner baffles to the body fabric.

The FIBC or big bag has a usable space or internal volume of about 750 l-1500 l, of about 1000 l-1300 l. Particularly, the FIBC or big bag has a capacity of 750 kg-1750 kg, 950 kg-1550 kg. The FIBC or big bag has a weight of about 2 kg-4 kg in an empty state.

The sealable fabric is manufactured by the following manufacturing steps:

Producing a yarn, e.g. by a tape line, wherein the yarn comprises components, particularly the proportions of the components, as delineated above.

Weaving the woven fabric from the yarn by use of a warp and weft technique.

Producing the sealable film by a multilayer blown film line, by a multilayer blown film coextrusion line.

Coating the woven fabric and the sealable film to produce the sealable fabric.

Particularly, the percentages disclosed in the present application refer to the weight fraction or percentage per weight (wt. %). Hence, the percentages may refer to the mass of a component to the total mass of the mixture and/or layer and/or part.

The abovementioned problem is solved by a method of manufacturing a Flexible Intermediate Bulk Container (FIBC) for receiving bulk material comprising providing at least one sheet of sealable fabric, wherein the FIBC is formed by sealing the at least one fabric forming a leak-proof seamless usable space having at least one body fabric and a bottom element, wherein sealing areas of the at least one sheet of sealable fabric are sealed together.

The above and further features and advantages of the invention will become more readily apparent from the following detailed description of preferred embodiments of the invention with reference to the accompanying drawings, in which like reference signs designate like features.

### BRIEF DESCRIPTION OF THE DRAWINGS

FIG. 1 is a schematic sectional view of a sealable fabric;

FIG. 2 is a schematic view of a woven fabric;

FIG. 3 is a schematic sectional view of a sealable film;

FIG. 4 is a schematic view of a FIBC according to a first embodiment;

FIG. 5 is a schematic view of a top element of the FIBC of FIG. 4;

FIG. 6 is a schematic view of a bottom element of the FIBC of FIG. 4; and

FIG. 7 is a schematic view of the inside of the FIBC of FIG. 4.

### DETAILED DESCRIPTION OF THE EMBODIMENTS

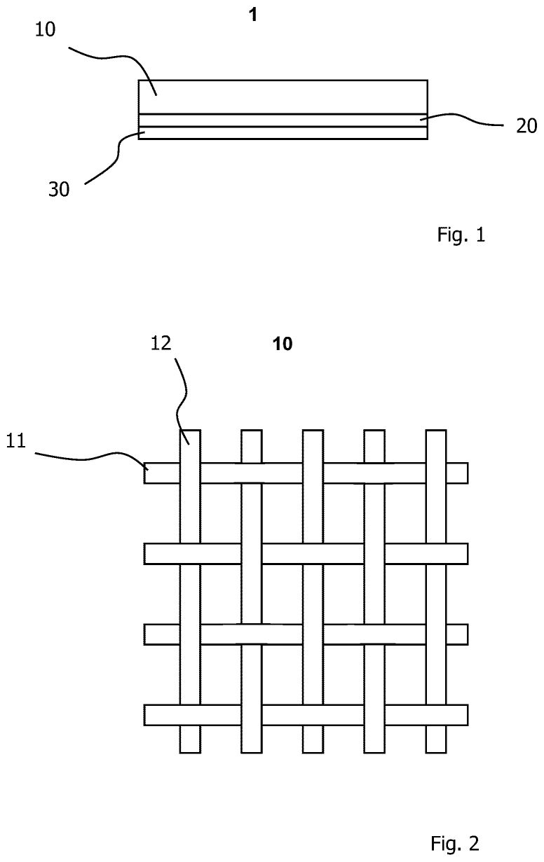

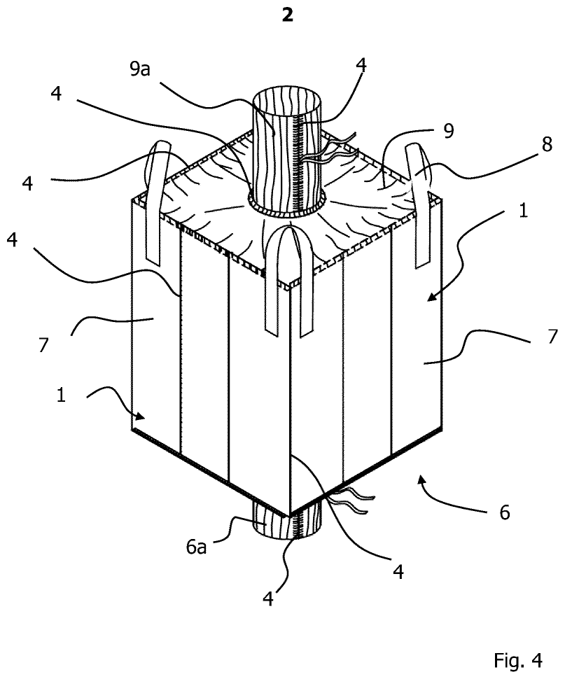

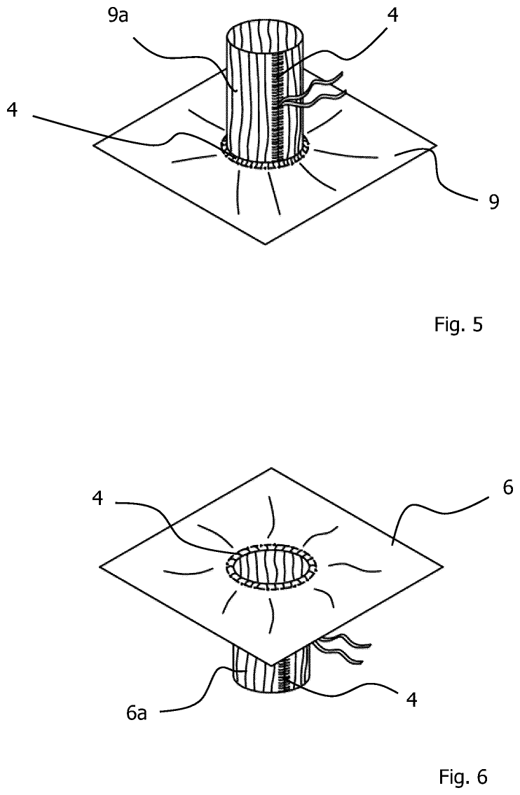

FIG. 1 depicts a sealable fabric 1 according to the invention. A plurality of sheets of the sealable fabric 1 are used to manufacture a Flexible Intermediate Bulk Container (FIBC) or big bag for receiving bulk material (FIGS. 4 and 5).

The sealable fabric 1 comprises a woven fabric 10, a coating 20 and a sealable film 30. The woven fabric 10 forms a first layer, the coating 20 forms a second layer and the sealable film 30 forms a third layer of the sealable fabric. The coating 20, i.e. the second layer of the sealable fabric 1, is sandwiched in between the woven fabric 10, i.e. the first layer of the sealable fabric 1, and the sealable film 30, i.e. the third layer of the sealable fabric 1.

The woven fabric 10 and the coating 20 each comprise polypropylene and sealable polypropylene. The sealable film comprises sealable polypropylene. Due to the high amount of polypropylene of the coating 20, the bonding between the woven fabric 10 and the sealable film 30 is increased. Hence, delamination of the sealable fabric 1 is avoided.

The woven fabric 10 according to FIG. 2 comprises a plurality of warp yarns 12 and weft yarns 11. The warp yarns 12 and the weft yarns 11 are interlacing at substantially right angles. Hence, the woven fabric 10 comprises a high strength in the direction of the yarns 11, 12. Accordingly, the woven fabric 10 forms the load-bearing layer of the sealable fabric 1. The yarns 11, 12 are made out of a mixture comprising polypropylene, sealable polypropylene resin, colorant, anti-splitting additives and ultraviolet (UV) protective additives. Thus, yarns 11, 12 are particularly manufactured solely by polypropylene with only limited other components. Hence, yarns 11, 12 having a high strength and a high resistance against environmental effects are provided.

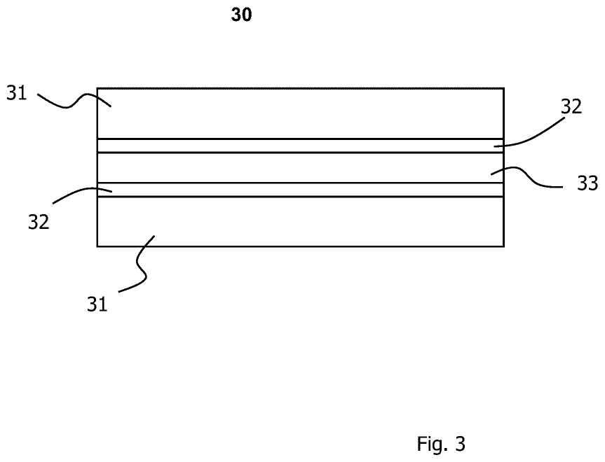

FIG. 3 depicts the sealable film 30. The sealable film 30 comprises two first layers 31, a second layer 33 and two third layers 32. The second layer 33 is in between the third layers 32. The third layers 32 and the second layer 33 are surrounded by the first layers 31 such that the third layers 32 and the second layer 33 are in between the first layers. Hence, the first layers 31 form the outer surface of the sealable film 30, so that the second layer 33 and/or the third layer 32 are not in contact with the surrounding. The first layer 31 substantially comprises solely sealable polypropylene, sealable polypropylene resin, to increase the bonding with the woven fabric 10 and/or the coating 20.

The second layer 33 is an internal layer. The second layer 33 comprises linear low-density polyethylene (LLDPE) and/or low-density polyethylene (LD-PE). Due to the polyethylene components of the second layer 33 the rigidity of the sealable film 30 is reduced and/or the flexibility of the sealable film 30 is increased.

The first layers 31 and the second layer 33 are bonded together by use of the third layer 32, which is in between the first layer 31 and the second layer. The third layer 32 comprises a tie material to increase the bonding between the polypropylene of the first layer 31 and the polyethylene of the second layer 32. Hence, delamination or other rupture of the sealable film 30 can be avoided.

FIG. 4 shows a FIBC 2 or big bag according to a first embodiment of the invention. The FIBC 2 comprises a plurality of body fabrics 7 forming side walls of the FIBC 2, a bottom element 6 and a top element 9.

The FIBC 2 additionally comprises a filling spout 9a attached to the top element 9 of the FIBC 2 as depicted in FIG. 5.

Moreover, a discharge spout 6a is provided that is attached to the bottom element 6 of the FIBC 2 as shown in FIG. 6.

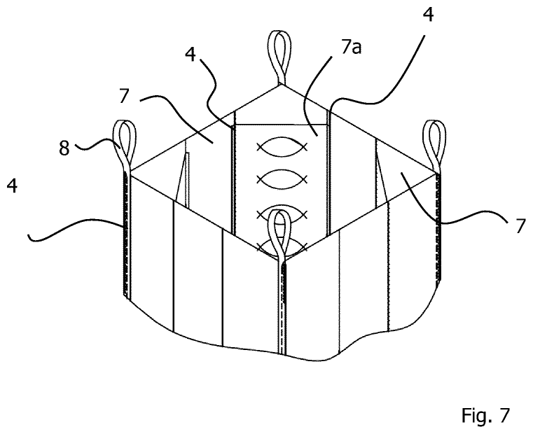

Additionally, inner baffles 7a are provided between two adjacent body fabrics 7 to increase the stability of the FIBC 2 and/or to give a formstable shape as depicted in FIG. 7.

The body fabrics 7 and/or the bottom element 6 and/or the top element 9 and/or the discharge spout 6a and/or the filling spout 9a and/or the inner baffles 7a are made of the sealable fabric 1. Particularly, the whole FIBC 2 is made of the sealable fabric 1.

Hence, the components of the FIBC 2, i.e. the body fabrics 7 and/or the bottom element 6 and/or the top element 9 and/or the discharge spout 6a and/or the filling spout 9a and/or the inner baffles 7a can be sealed or welded together at sealable areas 4 as indicated in FIG. 4-7

The sealable films 30 of two components of the FIBC 2, e.g. the body fabrics 7 and the bottom element 6, are joined together by a sealing process using heat. To seal two sealable fabrics 1 together, the sealable films 30 of adjacent sealable fabrics 1 placed on each other. Then heat is applied to the sealing area 4, to melt the sealable film 30 of the adjacent sealable fabrics 1, so that the sealable films 30 of the sealable fabrics 1 melt together and form a tight and stable bonding. Hence, a FIBC 2 containing multiple sheets of sealable fabrics 1 can be manufactured without any sewing process increasing the strength of the FIBC 2.

### LIST OF REFERENCE SIGNS

1 sealable fabric
2 FIBC
3 sealing area
4 opening
5 bottom element
6a discharge spout
7 body fabric
7a inner baffles
8 loop
9 top element
9a filling spout
10 woven fabric
11 weft yarn
12 warp yarn
20 coating
30 sealable film
31 first layer
32 third layer
33 second layer

What is claimed is:

1. Sealable fabric for a flexible intermedia bulk container (FIBC) for receiving bulk material comprising of:
a woven fabric comprising polypropylene,
a coating comprising polypropylene, and
a sealable film comprising sealable polypropylene.

2. Sealable fabric according to claim 1, wherein the woven fabric further comprises:
sealable polypropylene resin, and/or
colorant, and/or
protective additives.

3. Sealable fabric according to claim 1, wherein the woven fabric has a weight of 75 g/m²-235 g/m².

4. Sealable fabric according to claim 1, wherein the coating further comprises at least one of:
sealable polypropylene resin, and/or
linear low-density polyethylene (LLDPE).

5. Sealable fabric according to claim 1, wherein the coating (20) has a weight of 20 g/m²-30 g/m².

6. Sealable fabric according to claim 1, wherein the sealable film further comprises:
linear low-density polyethylene (LLDPE), and/or
low-density polyethylene (LD-PE), and/or
low fluidity polypropylene heterophasic copolymer, and/or tie material.

7. Sealable fabric according to claim 1, wherein the sealable film comprises at least one first layer and/or at least one second layer and/or at least one third layer.

8. Sealable fabric according to claim 7, wherein the first layer of the sealable film comprises at least 98%, sealable polypropylene.

9. Sealable fabric according to claim 7, wherein the second layer comprises the polyethylene.

10. Sealable fabric according to claim 7, wherein the first layer and the second layer are attached to each other by the third layer.

11. Sealable fabric according to claim 1, wherein the sealable film is a coextruded film.

12. Sealable fabric according to claim 1, wherein the sealable film is produced by a multilayer blown film coextrusion method.

13. Sealable fabric according to claim 1, wherein the sealable film has a thickness of 35 μm- 45 μm.

14. Flexible Intermediate Bulk Container (FIBC) for receiving bulk material comprising
at least one sheet of sealable fabric according to claim 1 that forms a leak-proof seamless usable space having at least one body fabric and/or a bottom element and/or a top element, wherein sealing areas of the at least one sheet of sealable fabric are sealed together.

15. Method of manufacturing a Flexible Intermediate Bulk Container (FIBC) for receiving bulk material comprising
providing at least one sheet of sealable fabric according to claim 1, wherein the FIBC is formed by sealing the at least one fabric forming a leak-proof seamless usable space having at least one body fabric and a bottom element, wherein sealing areas of the at least one sheet of sealable fabric are sealed together.
